(19) United States
(12) Patent Application Publication
(10) Pub. No.: US 2021/0220851 A1
(43) Pub. Date: Jul. 22, 2021

(54) Dispensing Lid and Pump for a Paint Pail

(71) Applicant: Port86, LLC, Helena, MT (US)

(72) Inventors: Patrick A. Williams, Helena, MT (US); Kimm L. Reid, Regina (CA)

(73) Assignee: Port86, LLC, Helena, MT (US)

(21) Appl. No.: 17/151,151

(22) Filed: Jan. 16, 2021

(30) Foreign Application Priority Data
Jan. 17, 2020 (CA) 3068511
May 14, 2020 (CA) 3081112
Jan. 14, 2021 (CA) 3106185

(51) Int. Cl. B05B 9/04; B05B 9/043

(52) U.S. Cl. CPC B05B 9/0413; B05B 9/043

(57) ABSTRACT

A dispensing lid and piston pump for a paint pail is provided. A manually actuatable piston pump is connected to a lid which can then be connected to a conventional paint pail. The pump can be operated to dispense paint or similar viscous products from a manufacturer-supplied container into another container, tray or the like. The base of the intake tube of the piston pump is positioned in close proximity to the interior bottom surface of the pail when the lid is installed on the pail. The lid includes an opening with a removable cover that can be used to return excess paint back to the pail without removing the lid. A paint stirring device rod is inserted through an accessory hole and a blade extending outwardly from the rod at a first end is operatively connected to the lid while the rod's second end extends above the lid.

### CROSS-REFERENCE TO RELATED APPLICATIONS

This patent application claims priority under 35 U.S.C. § 119 and the Paris Convention to Canada Patent Application Number ______ filed on Jan. ______, 2021. Also on these bases, this patent application further claims priority to the following Canadian Provisional Patent Applications:
Number 3,068,511, entitled “Paint Pail Pump and Dispensing Method”, and filed on Jan. 17, 2020; and
Number 3,081,112, entitled “Paint Pail Pump and Dispensing Method” filed May 14, 2020.
   The entire disclosures of these patent applications, which are all currently pending, are hereby incorporated by this reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF INVENTION

### 1. Field of the Invention

The invention relates to the field of paint application systems and methods and more specifically details a paint pail lid and pump for use in the dispensing of paint and similar viscous materials into applicator trays and the like, for use in simplified residential and commercial applications.

### 2. Description of Related Art

As in the case of many construction and building finishing trades, as well as home renovations and DlYers, there is consistent desire for enhanced efficiency and improved cost structures to provide ability for the delivery of services by tradespeople in a cost-efficient and mechanically effective manner. This extends to the field of painting—specifically painting of walls, other building surfaces and the like—which would typically be affected by the use of rollers or brushes in conjunction with a paint application container such as a tray or the like.

Paint is generally sold in a pail with a removable lid. Typical paint pail sizes include 1-gallon pails, which are often made of metal, and larger 5-gallon pails, which are often made of plastic. Regardless of the pail size and material, there are several problems associated with paint pails.

One problem with paint pails is that a user needs to remove the lid from the pail and then replace it back on the pail each time they need to get paint from the pail or return excess paint back into the pail. Every time the lid is removed, air gets into the pail which shortens the usable lifespan of the paint. Removing and replacing the lid also takes time, which can add up to a significant amount of time over a painting project, particularly for professional painters working on large-scale jobs.

Another problem associated with paint pails is that users generally pour paint from the pail into a paint tray or other application container. This is often a messy procedure that results in paint dripping down the side of the pail and pooling on the floor below the pail. The paint also gets into the rim of the pail during pouring, which can affect the ability of the lid to seal back on the pail. In the case of larger pails, for example 5-gallon pails, the pails are large, heavy and difficult to lift and maneuver to pour paint out of the pail. Lifting and pouring from such containers increases the chance of injury, including neck and back strain for the user.

Most prior art attempts at the use of large-format paint pails and similar containers center around the installation of an electric pump into the open cap hole of the 5-gallon pail, and the subsequent use of the electrical pump to dispense paint from the pail into the desired containers, or in other cases the 5-gallon or large-format bulk pail is actually fastened into a spraying or applicator system. The limitations to the use of these types of products limits them to job sites having electricity available and those products can be quite expensive. Smaller painting companies and individual painters may not always be able to have these products available to them. Applicator systems such as these often are also only useful in quite large jobsites, so they are not very desirable for use in smaller painting environments.

The inventors have recognized a need for improved systems for paint pails that allow for easy and quick removal of paint at a low cost.

### BRIEF SUMMARY OF THE INVENTION

In accordance with the invention, there is provided a paint pail lid with a manually actuated piston pump that can be attached to a conventional paint pail, allowing for the rapid and safe dispensing of paint from the pail into paint applicator trays or the like.

In one embodiment, there is provided a kit configured for attachment to a paint pail for pumping paint out of the paint pail comprising: a manually actuated piston pump having a downwardly extending tube into which the paint from an interior of the pail can enter, a depressible piston for actuating the piston pump, a spout for dispensing paint out of the piston pump, and a connector; and a lid configured for attachment to the paint pail, the lid having a hole for receiving the piston pump, a connection mechanism for connecting the piston pump connector to the lid in an air-tight manner such that the downwardly extending tube is positioned below a bottom surface of the lid and the spout is positioned above a top surface of the lid, and an opening having a cover moveable between an open position for allowing access to the interior of the paint pail and a closed position for preventing air from entering the interior of the paint pail; wherein when the piston pump and lid are is attached to the paint pail, actuating the piston draws paint from the paint pail up the tube and out the spout.

In some embodiments, the cover is pivotably attached to the lid. The cover may include a latch for securing the cover in the closed position. The cover may include a grasping member for a user to grasp to open or close the cover.

In some embodiments, the opening in the lid is semi-circular in shape.

In some embodiments, the lid further comprises an accessory hole having a removable cap.

In some embodiments, the connection mechanism is a threaded connection. The lid may include a flange around the hole having threads for connecting to corresponding threads on the piston pump connector.

In some embodiments, the piston is movable between a locked position which prevents actuation of the piston and an unlocked position wherein the piston can be actuated.

In some embodiments, the lid is configured for attachment to the pail using downward pressure applied to a top surface of the lid.

In some embodiments, the lid includes an annular recess on a bottom surface for operative connection to an annular lip on the paint pail.

In some embodiments, the kit further comprises a paint stirring device for operative connection to the accessory hole in the lid. The paint stirring device may comprise a rod for insertion into the accessory hole and at least one blade extending outwardly from the rod at a first end, wherein when the paint stirring device is operatively connected to the lid, a second end of the rod extends above the top surface of the lid.

In some embodiments, there is provided a kit configured for attachment to a paint pail for pumping paint out of the paint pail comprising: a manually actuated piston pump having a downwardly extending tube into which the paint from an interior of the pail can enter; a depressible piston for actuating the piston pump, the piston movable between a locked piston preventing actuation of the piston pump and an unlocked position allowing actuation of the piston pump; a spout for dispensing paint out of the piston pump; and a connector having threads; and a lid configured for attachment to the paint pail, the lid having: a hole for receiving the piston pump, the hole surrounded by a flange with threads for engaging the threads of the piston pump connector to connect the piston pump to the lid in an air-tight manner such that the downwardly extending tube is positioned below a bottom surface of the lid and the spout is positioned above a top surface of the lid; and an opening for allowing access to the interior of the paint pail; a cover pivotably attached to the lid and moveable between an open position for allowing access to the interior of the paint pail through the opening, and a closed position for preventing air from entering the paint pail through the opening, the cover further including a latch for securing the cover in the closed position; wherein when the piston pump and lid are attached to the paint pail, actuating the piston draws paint from the paint pail up the tube and out the spout.

In another aspect of the invention, there is provided a method of dispensing paint from a paint pail, comprising the steps: a) connecting a manually actuatable piston pump having an actuator to a lid such that a dispensing tube extends below a bottom surface of the lid and a spout is located above an upper surface of the lid; b) connecting the lid to the paint pail; and c) depressing the actuator on the piston pump to pump paint from the paint pail up the dispensing tube and out the spout.

In some embodiments, the lid comprises an opening between the top and bottom surface of the lid.

In some embodiments, in step a), the piston pump is threadingly connected in an airtight manner to a pump hole in the lid.

In some embodiments, in step a), a paint stirring device comprising a rod for insertion into an accessory hole and at least one blade extending outwardly from the rod at a first end is operatively connected to the lid while a second end of the rod extends above the upper surface of the lid. A user can attach an electric drill to the top end of the rod to rotate the rod and blade to stir the paint in the pail.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a perspective view of one embodiment of the paint pail lid and pump system attached to a paint pail, with the pump in its collapsed transport position.

FIG. 2 is a perspective view of one embodiment of the paint pail lid and pump system attached to a paint pail with the pump in its collapsed transport position, with the lid having an accessory hole.

FIG. 3 is a cross sectional side view of the embodiment of FIG. 1 along line A-A, with the pump in its extended dispensing position.

FIG. 4A is a top view of a paint pail lid and pump system in accordance with one embodiment.

FIG. 4B is a side view of a paint pail lid and pump system in accordance with one embodiment.

FIG. 5A is a top view of a paint pail lid with the pump removed, the lid including an accessory hole in accordance with one embodiment.

FIG. 5B is a side view of a paint pail lid with the pump removed in accordance with one embodiment, shown with the accessory hole having a cap on it and the cover to the opening being in an open position.

FIG. 6 is a bottom view of one embodiment of a paint pail lid with the pump removed and showing an annular ridge on the bottom surface of the lid for connecting to a conventional 1-gallon paint pail in accordance with one embodiment.

FIG. 7 is a bottom view of another embodiment of a paint pail lid with the pump removed and showing an annular recess and ribs on the bottom surface of the lid for connecting to a conventional 5-gallon plastic paint pail in accordance with one embodiment.

FIG. 8 is a side view of a paint pail pump removed from the lid in accordance with one embodiment.

FIG. 9 is a top view of the paint pail pump of FIG. 8.

FIG. 10 is a cross-sectional side view of the paint pail pump of FIGS. 8 and 9, taken along line B-B in FIG. 9.

FIG. 11A is a side view of one embodiment of a stirring device that can be used in conjunction with the accessory hole of the paint pail lid and pump.

FIG. 11B is a bottom view of the stirring device of FIG. 11A.

FIG. 12 is a cutaway side view of one embodiment of a paint pail lid and pump attached to a paint pail and having a stirring device.

### DETAILED DESCRIPTION OF THE INVENTION

With reference to the figures, a paint pail lid and pump system 10 for attachment to a paint pail 1 is described.

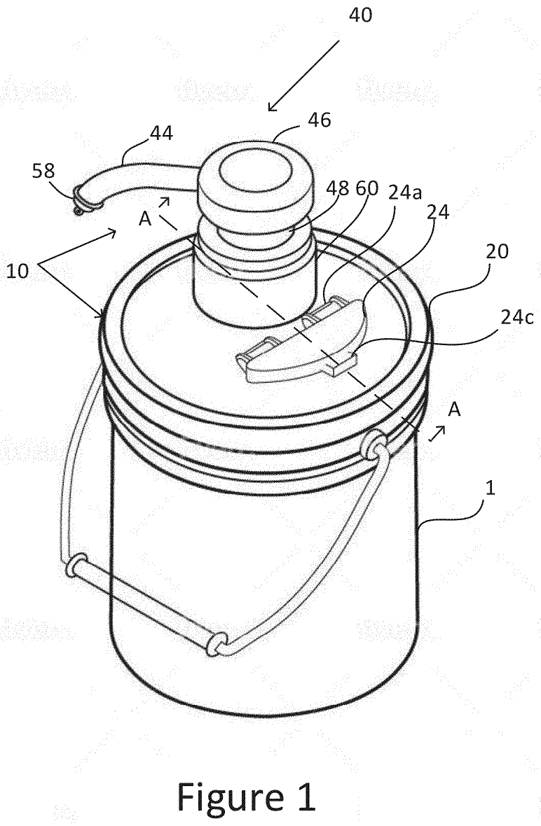

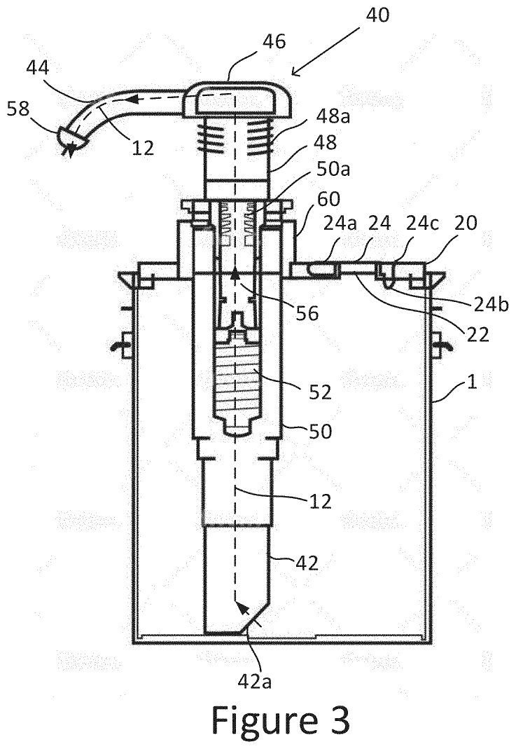

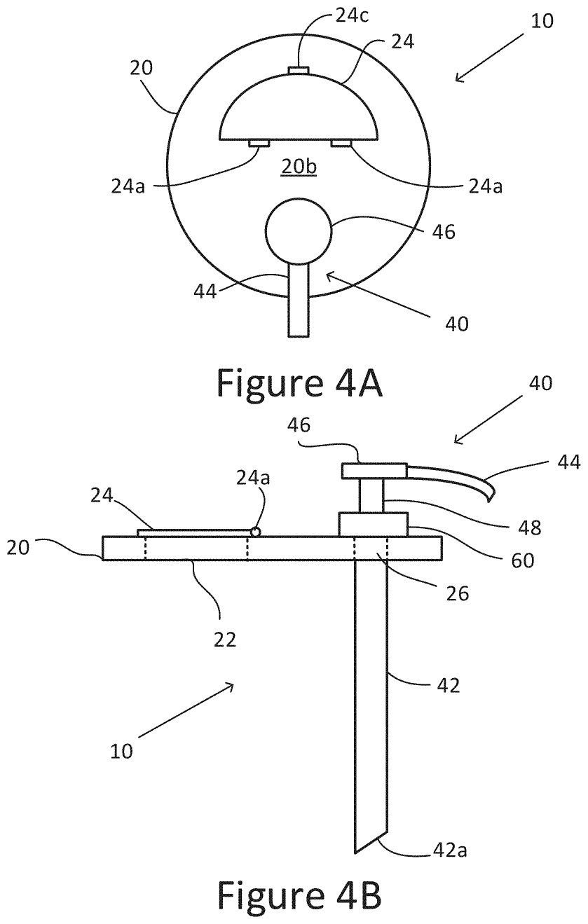

Referring to FIGS. 1 to 4B, the lid and pump system 10 comprises a lid 20 and a manually actuated piston pump 40 that is attachable to the lid 20. The lid is configured to attach to a paint pail 1 to replace a conventional paint pail lid, as shown in FIGS. 1 to 3. The piston pump 40 attaches to the lid such that a tube 42 of the piston pump extends below a bottom surface 20a of the lid, and a spout 44 and pump head 46 are located above a top surface 20b of the lid. When the lid and pump system 10 is attached to a paint pail 1, actuating the piston pump 40 by pressing down on the pump head 46 causes paint to move from the pail up through the tube 42 and out the spout 44 of the piston pump 40, shown by arrows 12 in FIG. 3 (note that the cap 58 shown in FIG. 3 would need to be removed for the paint to be pumped). This allows paint to be pumped from the interior of the paint pail 1 into a paint tray or other container without removing the lid 20 from the pail.

The Lid

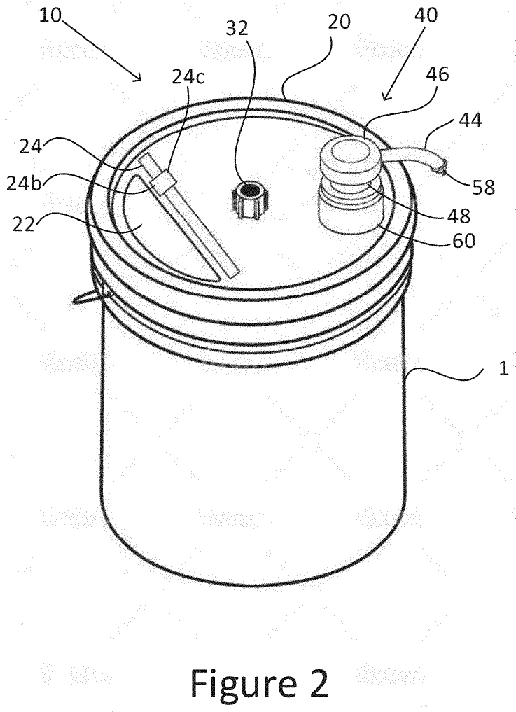

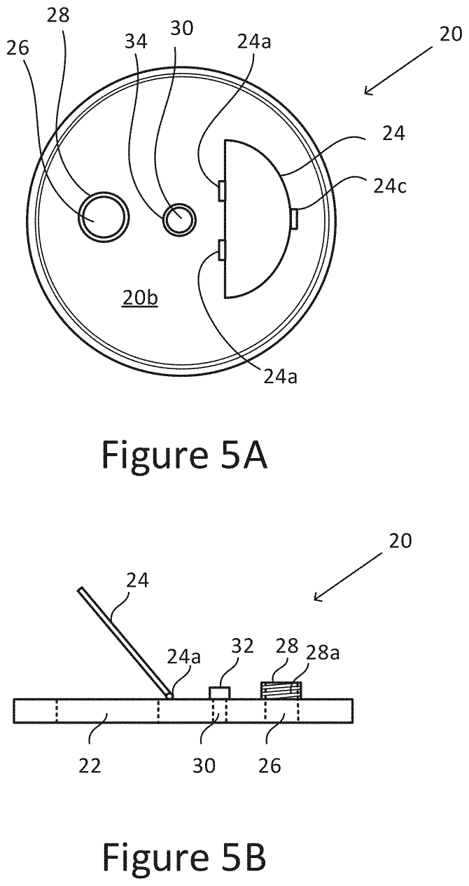

The lid 20 is shown on its own in FIGS. 5A, 5B, 6 and 7. The lid comprises an opening 22 having a cover 24 which is movable between an open position (shown in FIGS. 2 and 5B) and a closed position (shown in FIGS. 1 and 5A). The opening 22 and cover 24 on the lid 20 serve several purposes. The opening allows a user to pour excess paint back into the pail without removing the lid 20. It also allows for the use of a paint sprayer or another accessory that requires access to the interior of the pail. For example, a user can insert the hose of a paint sprayer into the pail through the opening 22.

When the cover 24 is in the closed position, it covers the opening 22 in an airtight manner to prevent airflow through the opening which would oxidize the paint in the pail. When the cover 24 is open, the opening 22 allows access to the interior of the pail without removing the lid 20.

The opening 22 is illustrated as semi-circular in shape, although another shape of opening can be used.

In some embodiments, the cover 24 is a pivotable cover connected to the lid 20 via one or more hinges 24a that includes a latch 24b for securing the cover to the lid 20 in the closed position, and a grasping member 24c to allow a user to grasp the cover 24 to open it.

The lid 20 is configured to attach to a paint pail in the same manner as a conventional paint pail lid. Various configurations of the lid can be used, depending on the type of paint pail that it is designed to attach to.

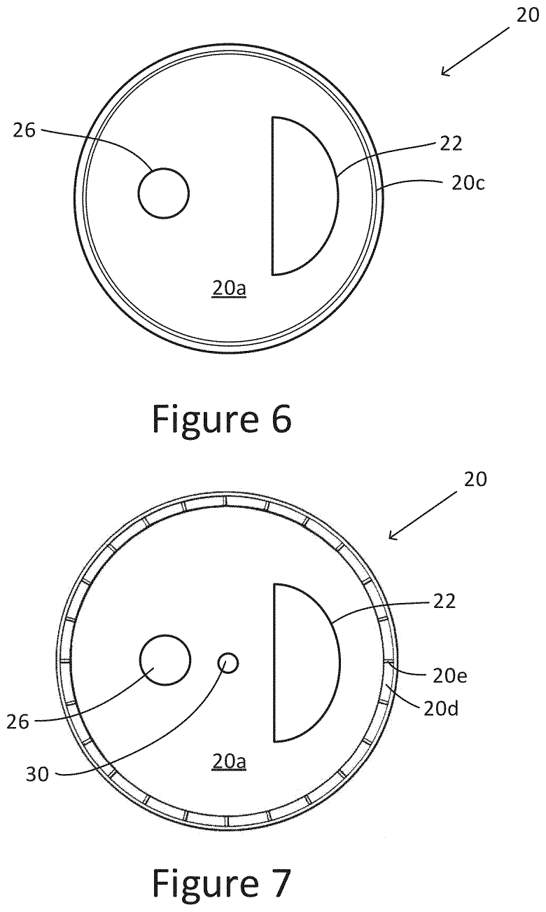

For example, as shown in FIG. 6, the lid 20 may be configured to attach to a conventional 1-gallon metal paint pail by including an annular ridge 20c on its bottom surface 20a. The annular ridge 20c is configured to fit into an annular groove around the top of a conventional paint pail.

In another example, shown in FIG. 7, the lid 20 is configured to attach to a conventional 5-gallon plastic paint pail in the same manner as a conventional paint pail lid. In this embodiment, the bottom surface 20a of the lid 20 includes an annular recess 20d adjacent the outer circumference of the lid having radially extending ribs 20e spaced around the circumference of the annular recess. The recess 20d receives a circumferential lip around the top opening of a paint pail, with the ribs 20e hooking around an undercut around the rim of the pail to attach the lid 20 to the pail 1, as is known in the art.

In another example, the lid 20 can attach to the paint pail using a threaded connection.

The lid 20 also comprises a pump hole 26 for receiving the piston pump 40 and an attachment mechanism for securing the piston pump to the lid 20. As shown in FIG. 5B, the attachment mechanism on the lid 20 may include an annular wall 28 extending upwardly from the top surface 20b of the lid 20 around the circumference of the pump hole 26. The annular wall 28 has threads 28a on its outer surface to threadingly engage with corresponding threads on the piston pump 40 to connect the piston pump 40 to the lid 20 in an airtight manner.

In some embodiments, the lid 20 includes an accessory hole 30, as shown in FIGS. 2, 5A and 5B, that extends through the lid from the top surface 20b to the bottom surface 20a. The accessory hole 30 can receive various painting accessories, such as a paint stirring mechanism, which is described in more detail later. The accessory hole 30 includes a cap 32, as shown in FIGS. 2 and 5B, which covers the accessory hole 30 in an airtight manner when it is not being used. The cap 32 may screw onto the lid 20, such as by means of an annular wall 34 (see FIG. 5A) around the circumference of the accessory hole 30 on the top surface 20b of the lid, the annular wall having threads to engage threads in the cap 32.

The Piston Pump

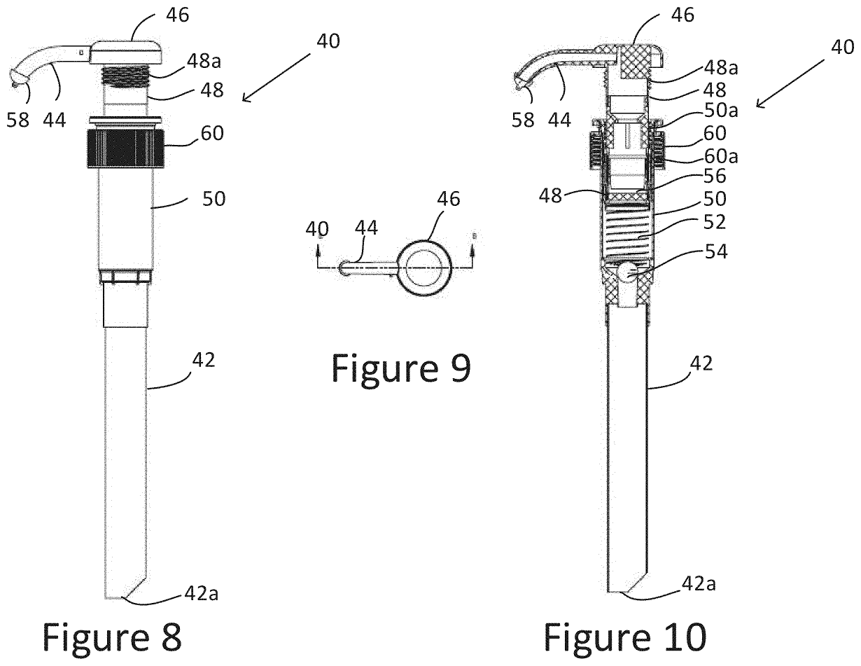

The piston pump 40 is shown attached to the lid in FIGS. 1 to 4B and on its own in FIGS. 8 to 10. The piston pump 40 is a manually actuated piston pump, which is known in the art for other applications. These types of pumps act much like an air suction device to draw paint from the pail 1 up through the tube 42 and out the spout 44. When a user presses down on the pump head 46, the piston 48 inside of the housing 50 moves down to compress the spring 52, and air pressure draws a ball 54 upwards along with paint inside a chamber 56 in the housing 50. As the pump head 46 is released, the spring 52 returns the piston 48 and the pump head 46 back to its resting position, along with the ball 54, thereby sealing the chamber 56 in the housing to prevent the paint from flowing back down the tube 42 and into the pail 1. The first one or more cycles of actuating the pump primes the pump to draw the paint into the chamber 56, and subsequent actuations of the pump dispense the paint from the chamber out the spout 44.

The piston pump 40 preferably has a locked position and an unlocked position. In the locked position, shown in FIGS. 1 and 2, the pump head 46 and piston 48 are locked in a downward position at the bottom of the piston stroke to prevent further movement of the piston. This may be done by rotating the piston 48 to engage threads 48a on the piston with threads 50a in the housing 50. To unlock the piston pump, the pump head 46 and piston 48 are rotated in the opposite direction to unlock the threads, after which the spring 52 causes the piston to move into the upper position for subsequent actuation.

The piston pump 40 preferably includes a cap 58 that can attach to the end of the spout 44 to cover the spout opening when the pump is not being used. This prevents air from entering the spout which prevents any leftover paint in the spout 44 and chamber 56 from drying out between uses and clogging the spout and chamber. The cap 58 may be connected to the piston pump 40, for example by a cord, so that it is not misplaced when it is removed from the spout.

The piston pump 40 includes a connection mechanism for connecting the piston pump to the lid 20 in an airtight manner. Preferably, the piston pump 40 includes a connection cap 60 around the housing 50 with internal threads 60a for connecting to the threaded annular wall 28 around the pump hole 26 in the lid 20.

The tube 42 of the piston pump 40 is configured such that the bottom end 42a of the tube is in close proximity to or touching the interior bottom surface of the pail 1, as shown in FIG. 3. The tube 42 may be shaped such that the bottom end 42a is cut at an angle, as shown in FIGS. 8 and 10. This tube shape and configuration allows for most of the paint in the pail to be pumped out using the piston pump.

The piston pump tube 42 can be manufactured at the necessary length to fit in standard paint pails. Alternatively, the tube 42 can be collapsible or telescoping to allow the bottom end 42a to move or collapse upward to position itself in the appropriate position in relation to the bottom interior surface of the pail.

Paint Stirrer Accessory Device

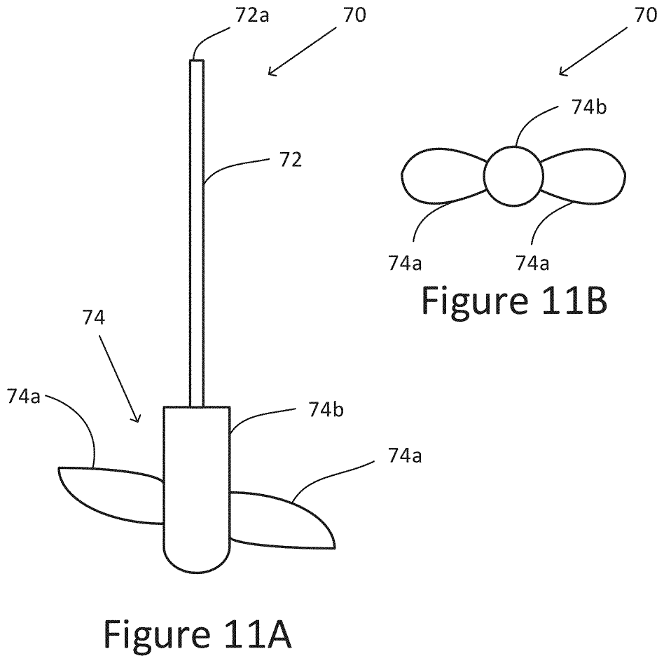

The lid and pump system 10 can be used with a paint stirring device 70 which engages with the lid 20 through the accessory hole 30 such that the paint stirrer extends inside the paint pail 1. One embodiment of the paint stirring device 70 is shown in FIGS. 11A and 11B, wherein the paint stirrer comprises a rod 72 with a propeller 74 at the bottom end of the rod 72. The propeller 74 has one or more blades 74a extending outwardly from a central hub 74b.

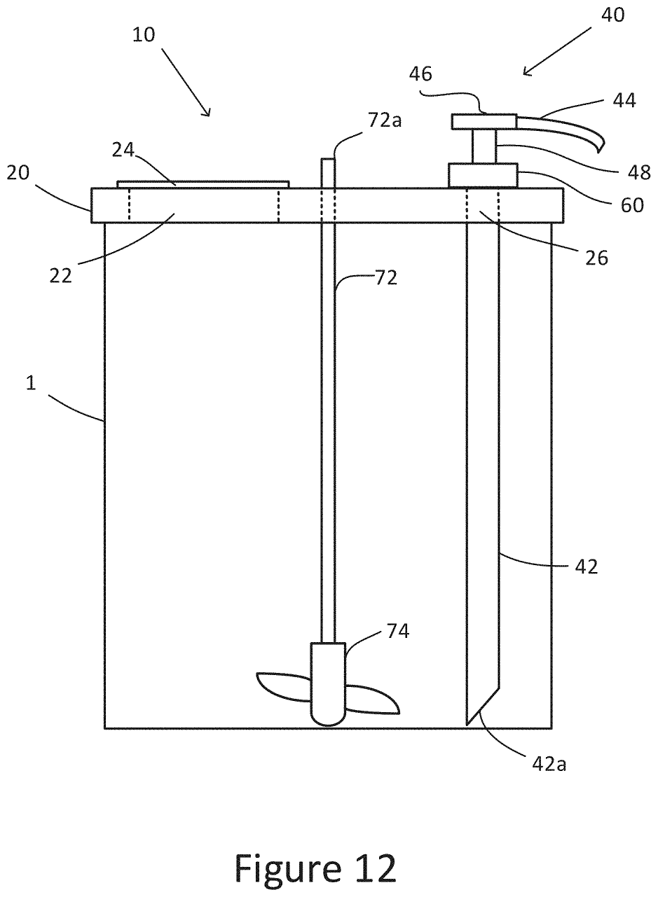

The rod 72 of the paint stirring device 70 can be inserted through the accessory hole 30 in the lid 20, as shown in FIG. 12, such that the propeller is in close proximity to the bottom interior surface of the pail 1 and a top end 72a of the rod extends above the lid 20. A user can attach an electric drill to the top end 72a of the rod to rotate the rod 72 and propeller 74 to stir the paint in the pail. When the stirring device 70 is not being used, the cap 32 can cover the accessory hole 30 without having to remove the stirring device 70 from the hole.

Use of the System

To use the lid and pump system 10, a user attaches the lid 20 and piston pump 40 using the threaded connection and then secures the lid to the paint pail 1. The user can then pump paint out of the pail using the piston pump into a paint tray or other container. The user may put the cap 58 on the piston pump spout 44 after dispensing paint to prevent paint from drying in the spout. Once the user is finished painting, they can open the cover 24 to access the opening 22 and pour any leftover paint back into the pail 1 through the opening. The cover can then be closed to seal the paint pail.

Additional Details

The system and method of the present invention can be practiced with a paint pail of any size. As outlined above with respect to the prior art, many job sites will use a 5-gallon bulk pail, or a 1-gallon can or pail of paint and similar sized containers could be used within the scope of the present invention. However, it will also be understood that the system and method of the present invention could be used with containers of literally any kind with necessary adaptation to accommodate or fit such a container and any such a container size is contemplated within the scope of the present invention. It may even be the case that the method of the present invention permitted explicitly the use of containers of a larger or modified size for use in different work environments and any such modification and container size will be understood to those skilled in the art and such containers along with the attendant modifications to the remainder of the apparatus of the present invention will all be understood to be intended to be within the scope of the claimed invention. For example, the pumping system of the present invention may need to be modified in size to fit a different sized container, and that will be easily understood to be within the intended scope hereof.

In further embodiments of the paint dispensing approach of the present invention, the piston pump 40 can be manufactured such that it engages the standard form of spout opening on pre-manufactured paint pails, for interchangeable use on more than one pail. In such a case, the piston pump would include an attachment mechanism capable of engaging the spout opening of a pail. The pump could also be sold with more than one adapter rendering it capable of engaging the spout opening of multiple types of pails. It will be understood that virtually any type of an adapter capable of attaching the piston pump 40 of the present invention to the spout opening of the lid of the paint pail 1 will all be contemplated within the scope of the present invention.

In other embodiments, the downward extending intake tube 42 is simply a flexible hose which when lowered into position within the pail 1 is long enough to reach the lower interior surface, and with a spacer that would simply bend into an appropriate position in relation to the lower interior surface to properly intake paint from the interior of the pail 1 when the pump 40 is actuated.

In some embodiments, the piston pump 40 can be re-used in multiple manufactured paint pails 1. A rigid downwardly extending intake tube 42 could be used with a collapsible bottom section and spacers, again resulting in the ideal positioning of the intake of the pump 40 in relation to the lower interior surface of the pail 1. Alternatively, the downwardly extending intake tube 42 might be flexible and of sufficient length to reach the proximity of the lower interior surface, with or without a spacer attached thereto, or it might comprise a rigid downwardly extending intake tube with or without a telescoping or collapsible section at the bottom thereof capable of collapsing or telescoping into an appropriate position in relation to the lower interior surface.

The piston pump 40 may include an adapter of any type capable of engaging the spout opening or cap opening of a paint lid. One or more adapters could be sold along with the remainder of the pump 40 to permit for the engagement of multiple types of cap openings. An adapter kit of this nature sold along with the remainder of the pump 40 is also contemplated to be within the explicit scope of the present invention.

It will be apparent to those of skill in the art that by routine modification the present invention can be optimized for use in a wide range of conditions and application. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context.

The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

What is claimed is:

1. A kit configured for attachment to a paint pail for pumping paint out of the paint pail comprising:
a manually actuated piston pump having:
a downwardly extending tube into which the paint from an interior of the paint pail can enter,
a depressible piston for actuating the piston pump,
a spout for dispensing the paint out of the piston pump, and
a piston pump connector; and
a lid configured for attachment to the paint pail, the lid having:
a hole for receiving the piston pump,
a connection mechanism for connecting the piston pump connector to the lid in an air-tight manner such that the downwardly extending tube is positioned below a bottom surface of the lid and the spout is positioned above a top surface of the lid, and
an opening having a cover moveable between an open position for allowing access to the interior of the paint pail and a closed position for preventing air from entering the interior of the paint pail;
wherein when the piston pump and the lid are attached to the paint pail, actuating the depressible piston draws the paint from the paint pail up the tube and out the spout.

2. The kit as in claim 1, wherein the cover is pivotably attached to the lid.

3. The kit as in claim 1, wherein the cover includes a latch for securing the cover in the closed position.

4. The kit as in claim 1, wherein the cover includes a grasping member for a user to move the cover between the open position and the closed position.

5. The kit as in claim 1, wherein the opening in the lid is semi-circular in shape.

6. The kit as in claim 1, wherein the lid further comprises an accessory hole having a removable cap.

7. The kit as in claim 1, wherein the connection mechanism is a threaded connection.

8. The kit as in claim 1, wherein the lid includes a flange around the hole having threads for connecting to corresponding threads on the piston pump connector.

9. The kit as in claim 1, wherein the depressible piston is movable between a locked position which prevents actuation of the depressible piston and an unlocked position wherein the depressible piston can be actuated.

10. The kit as in claim 1, wherein the lid is configured for attachment to the paint pail using downward pressure applied to the top surface of the lid.

11. The kit as in claim 1, wherein the lid includes an annular recess on a bottom surface for operative connection to an annular lip on the paint pail.

12. The kit as in claim 6, further comprising a paint stirring device for operative connection to the accessory hole in the lid.

13. The kit as in claim 12, wherein the paint stirring device comprises a rod for insertion into the accessory hole and at least one blade extending outwardly from the rod at a first end, wherein when the paint stirring device is operatively connected to the lid, a second end of the rod extends above the top surface of the lid.

14. A kit configured for attachment to a paint pail for pumping paint out of the paint pail comprising:
a manually actuated piston pump having:
a downwardly extending tube into which the paint from an interior of the paint pail can enter,
a depressible piston for actuating the piston pump, the depressible piston movable between a locked position preventing actuation of the piston pump and an unlocked position allowing actuation of the piston pump,
a spout for dispensing the paint out of the piston pump, and
a piston pump connector having threads; and
a lid configured for attachment to the paint pail, the lid having:
a hole for receiving the piston pump, the hole surrounded by a flange with threads for engaging the threads of the piston pump connector to connect the piston pump to the lid in an air-tight manner such that the downwardly extending tube is positioned below a bottom surface of the lid and the spout is positioned above a top surface of the lid, and
an opening for allowing access to the interior of the paint pail,
a cover pivotably attached to the lid and moveable between an open position for allowing access to the interior of the paint pail through the opening, and a closed position for preventing air from entering the paint pail through the opening, the cover further including a latch for securing the cover in the closed position;
wherein when the piston pump and the lid are attached to the paint pail, actuating the depressible piston draws the paint from the paint pail up the downwardly extending tube and out the spout.

15. The kit as in claim 14, further comprising a paint stirring device for operative connection to an accessory hole in the lid.

16. The kit as in claim 15, wherein the paint stirring device comprises a rod for insertion into the accessory hole and at least one blade extending outwardly from the rod at a first end, wherein when the paint stirring device is operatively connected to the lid, a second end of the rod extends above the top surface of the lid.

17. A method of dispensing paint from a paint pail, comprising the steps:
a) connecting a manually actuatable piston pump having an actuator to a lid such that a dispensing tube extends below a bottom surface of the lid and a spout is located above an upper surface of the lid;
b) connecting the lid to the paint pail; and
c) depressing the actuator on the piston pump to pump paint from the paint pail up the dispensing tube and out the spout.

18. The method of claim 17, wherein the lid comprises an opening between the upper surface and the bottom surface of the lid.

19. The method of claim 17, wherein in step a), the piston pump is threadingly connected in an airtight manner to a pump hole in the lid.

20. The method of claim 17, wherein in step a), a paint stirring device comprising a rod for insertion into an accessory hole and at least one blade extending outwardly from the rod at a first end is operatively connected to the lid while a second end of the rod extends above the upper surface of the lid.
